(19) United States
(12) Patent Application Publication
(10) Pub. No.: US 2009/0328106 A1
(43) Pub. Date: Dec. 31, 2009

(54) Video content control system with automatic content selection

(76) Inventor: Gutman Levitan, Stamford, CT (US)

Correspondence Address: Gutman Levitan, 101 Grove Street, Apt 11, Stamford, CT, 06901, US

(21) Appl. No.: 12/215,591

(22) Filed: Jun. 30, 2008

(51) Int. Cl. H04N 5/445; H04N 7/173

(52) U.S. Cl. 725/46; 725/87

(57) ABSTRACT

For selection of entertainment of the most personal interest to a user, a video content control system processes records of video programs against user data. A program record contains data pertinent to user preferences and an impartial rating of program quality or significance determined with no regard to preferences of individual users. The processing is defined by decision tables. For a particular combination of user data and program data pertinent to user preferences, a decision table specifies a value of change to be applied to the impartial rating to produce a personal rating as an increased, decreased or unchanged impartial rating. The system selects videos with the highest personal ratings, i.e. videos that are impartially the best and compliant with user preferences.

### BACKGROUND OF THE INVENTION

This invention relates to information technology for television and, more specifically, to video content management.

With hundreds of television channels provided by cable, satellite and telecom operators a viewer faces hundreds of choices and with video on demand he faces thousands of choices. But for computer processing neither hundred nor thousand nor million is a problem. Supplementing user's direct choices with automatic content selection is important for advancement of digital television and for incoming convergence of television and the Internet.

U.S. Pat. Nos. 4,745,549 and 5,075,771 to Hashimoto disclose a system for selecting television programs suitable for individual user taste. User data is obtained from a questionnaire filled by the user. Television program data is processed against the user data by the method of linear programming for generating an optimal list of selected programs. The program list is then used to automatically control TV or VCR.

U.S. Pat. No. 5,223,924 to Strubbe describes a user interface that can access TV program information and automatically correlate this information with the preferences of the user. In the system, the user specifies whether he “likes” a particular video program to create a personalized TV guide.

U.S. Pat. Nos. 5,758,257, 6,020,883 and 6,088,722 to Herz et al. describe a system that determines the attractiveness of video programs to a customer by comparing the customer profile to the profiles of available video programs using an “agreement matrix”. The customer profile is determined from customer questionnaires, customer demographics, relevance feedback techniques, default profiles, and the like. The content profile is determined from questionnaires completed by “experts” or customers' panel, or generated from the text of video program description. The agreement matrix determines a “distance” between a customer profile and a content profile in a multidimensional characteristic space.

U.S. Pat. Nos. 6,614,987 and 7,370,342 to Ismail et al. disclose a system for delivery of targeted video programming that monitors viewer's watching habits to create viewer's profile. It determines viewing preferences by monitoring viewing time and processing information on the viewed programs provided by the program guide. The system selects among available video segments to create customized programs, which may include targeted content and targeted advertising.

U.S. Pat. No. 7,096,486 to Ukai et al. describes a system that provides a TV program selection support according to viewer's preferences derived from the viewing history. For each viewed program the system determines a “view score” obtained by dividing a program view time by program duration and applies the score to program data provided in electronic program guide.

Being preoccupied with user individual preferences, the prior art misses the point that notwithstanding differences between users all of them want to watch good movies, most significant sport events and so on, rather than bad movies and insignificant events. The feature of video program that determines its success in attracting large audiences can be represented by an impartial rating of that program, which is an impartial assessment of its quality or significance with no regard to preferences of individual users. In fact, some TV guides rate movies on quality by 0 to 4 stars. Because quality of selected video content is at least as important as its compliance with user preferences, an impartial rating should be an essential factor in the process of content selection.

### SUMMARY

Accordingly, it is an object of the present invention to provide a system for automatic selection of high quality video content that is compliant with user individual preferences. The system provides the user with the most enjoyable entertainment while reducing exposure to everything that is going to be boring, annoying or unacceptable for any reason.

Another object is to provide the user with a video content control system that takes full advantage of automatic content selection.

In keeping with these objects, the present invention consists, briefly stated, in processing program records against a user record, wherein the user record contains data representing user preferences and program record contains program data pertinent to user preferences and in addition, a program impartial rating. The processing is defined by decision tables. For a particular combination of user data and program data pertinent to user preferences, a decision table specifies a value of change to be applied to the program impartial rating to produce a personal rating as an increased, decreased or unchanged impartial rating. Video programs with higher personal ratings are considered of greater interest to the user than programs with lower personal ratings. Limited number of videos with the highest personal ratings is presented to the user.

The novel features, which are considered as characteristic for the present invention, are set forth in particular in the appended claims. The invention itself, however, will be best understood from the following description of specific embodiment when read in connection with the accompanying drawings.

### BRIEF DESCRIPTION OF THE DRAWINGS

FIG. 1 shows user's options provided by a video content control system with automatic content selection.

FIG. 2 is a functional diagram of the video content control system.

FIG. 3 is a diagram of the selection process.

FIG. 4 illustrates acquisition and processing of user's preferences related to sports.

FIG. 5 illustrates acquisition and processing of user's data related to controversial features of video content.

FIG. 6 illustrates acquisition and processing of user's data related to art movies.

FIG. 7 illustrates acquisition and processing of user's data related to old movies.

### DESCRIPTION OF THE PREFERRED EMBODIMENTS

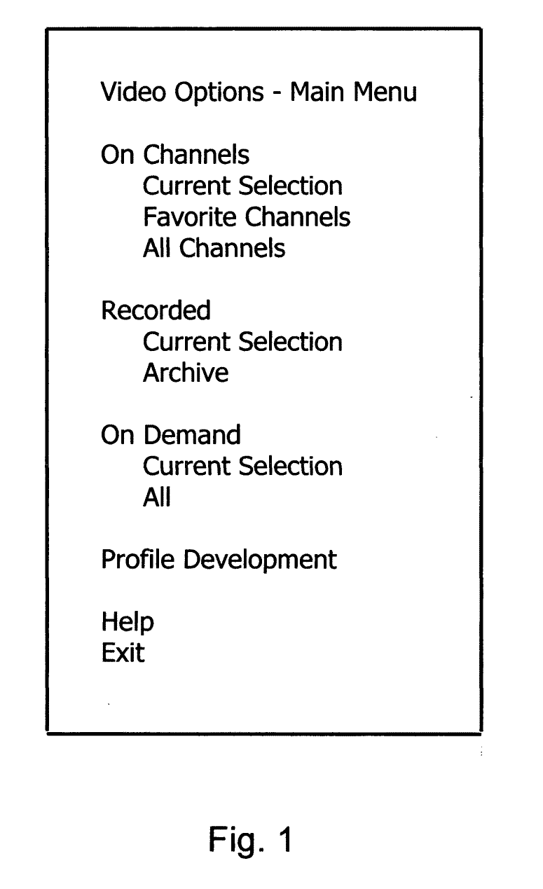

Digital television provides a user with hundreds of programs that are simultaneously transmitted on cable, satellite or telecom TV channels, another hundreds that could be stored in a digital video recorder (DVR) and thousands more that are available on demand. FIG. 1 shows user's options provided by a video content control system with automatic content selection. Videos that are scheduled for transmission on TV channels can be accessed in three ways. Current selection option provides access to limited number, for example ten, best programs automatically chosen among all programs transmitted in the current time zone. Favored channels option limits channel surfing to a dozen of channels chosen by the user as his favorite and all channels option provides access to any channel selected by its number.

Recorded videos are divided in two parts: current selection and archive. Current selection option provides access to limited number of recorded or downloaded videos that include programs selected by the user and programs selected automatically. The current selection list is a dynamic one: programs that have been viewed are removed and programs of lesser interest to the user are replaced by programs of greater interest on a daily basis. At the same time, any program could be moved to archive, which is a library of videos saved for future viewing. A video is stored in archive until the user deletes it.

In video on demand, current selection presents a list of recommended videos that are automatically selected among thousands available. The current selection does not contain videos that the user has ordered before.

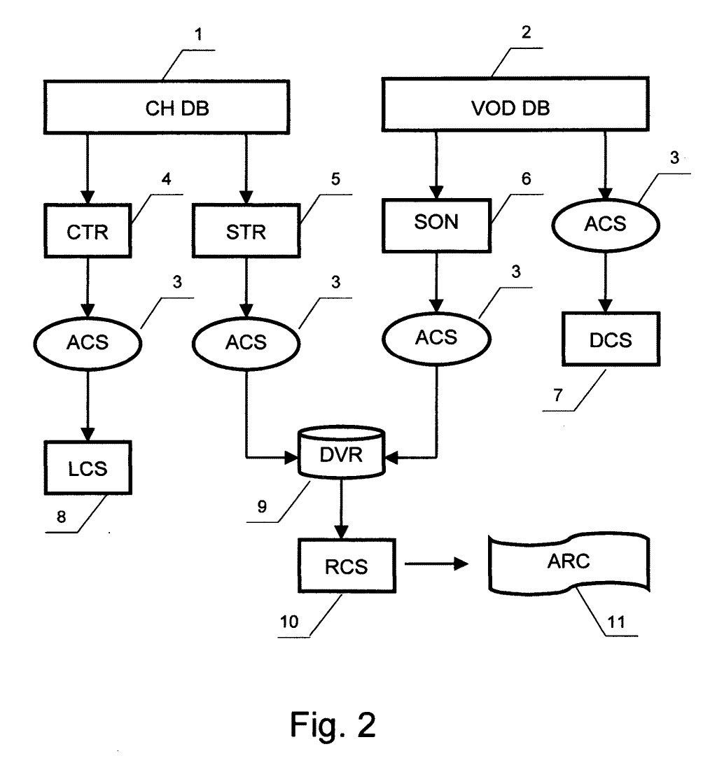

FIG. 2 shows a functional diagram of the video content control system. It operates with two sources of video content: videos that are scheduled for transmission on TV channels and videos that are available on demand (VOD). Information on programming scheduled on TV channels is available in channel database 1 and information on VOD videos is available in VOD database 2. The videos scheduled on TV channels are defined separately as a set 4, which includes currently transmitted and therefore available for immediate viewing videos, and a set 5, which includes videos available for recording at the time of their scheduled transmission. An automatic content selection process 3, when applied to the set 4, produces a set of “live” programs 8 available to the user as the current selection of videos on channels. The same process, when applied to the set 5, contributes to a set of videos 10 that are recorded by a DVR 9. The user sees the set 10 as the current selection of recorded videos.

Being applied to VOD database 2, the selection process 3 produces a set of recommended programs 7 that the user sees as the current selection of on demand videos.

On demand video can be delivered either in interactive or broadcast mode. Each mode has upside and downside. Interactive delivery is immediate or almost immediate while broadcasting is scheduled. On the other hand, in the interactive mode a separate copy of ordered content is delivered to each user's receiving device while in the broadcast mode, the same signal and therefore the same single “copy” is delivered to all receiving devices simultaneously. Thus for popular content, broadcast delivery provides tremendous bandwidth saving. Also it should be understood that live events can be watched live only during their real-time transmission and therefore simultaneously by all viewers. It makes no sense to deliver a separate copy of live event to each user. As to “taped” events and shows, there is not much urgency to view them immediately. A taped video can be transmitted overnight so that all receiving devices that ordered the video during the day could download it simultaneously. Then each user can watch the video downloaded in his device at the time of his choice.

Another advantage of VOD broadcasting is that an ordered video can be downloaded not only by receiving devices of those users who ordered the video but also by all receiving devices that automatically select the video from a broadcast schedule. A VOD broadcast schedule 6 is similar to the channel broadcast schedule 5. The selection process 3, when applied to the set of videos 6 scheduled for transmission overnight, contributes to the set of recorded videos 10.

User direct choices have priority over automatic selections. If the current selection of recorded videos 10 is limited to ten video programs and the user has selected three programs using channel or VOD options shown in FIG. 1, then the remaining seven programs to be recorded will be selected automatically. If user has selected no programs then all ten programs to be recorded will be selected automatically.

The current selection of recorded videos 10 is managed automatically. Each video that has been viewed is removed so that a new video could be included in the current selection. The removal is delayed to the next recording cycle so that the user would have time for saving the video in archive 11. Preferably a recording cycle starts each day at 8:00 a.m. In addition, in a new recording cycle all video programs of lesser interest to the user are replaced by programs of greater interest if such programs are scheduled for transmission during the new recording cycle. This way the system provides over time an accumulation of best programs ever transmitted via the video distribution network so that a user would never miss the best programs no matter at what time the programs are transmitted and how much time the user spends on watching television.

Archive 11 is a library of videos saved for future viewing. A video is stored in archive until the user deletes it. The number of archived videos is not limited.

User's receiving device may be a computer with a video input, a cable or satellite set-top box, a computer with video input and video output connected to a TV set or a TV set with embedded computer.

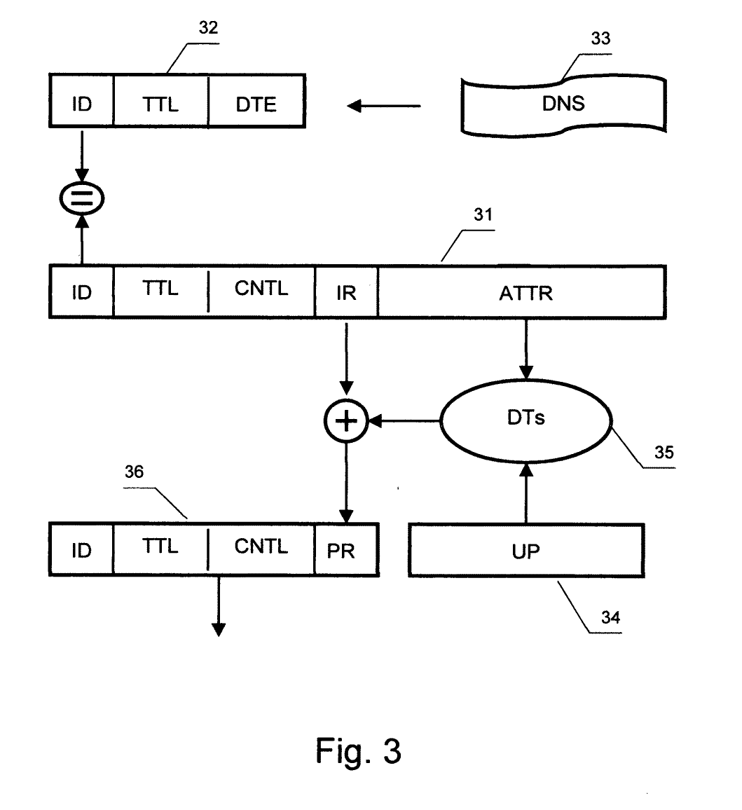

The selection process 3 is illustrated by FIG. 3. An input program record 31 contains a program identification number, a program tittle, control data, a program impartial rating and program attributes pertinent to user preferences. Control data specifies the type of video codec and other information that is relevant to program playing but not to content selection. The program impartial rating is an impartial assessment of the program in regard to its quality or significance and with no regard to preferences of individual users. The program record is prepared by professionals whose job is populating the program information databases 1 and 2 shown in FIG. 2. In determining the program impartial rating and the program attributes pertinent to user preferences they may rely on their own judgement as well as on all available information.

The program record is checked first against a do-not-select list 33. The purpose of this step is prevention of automatic selection of the same video program over and over again. The list 33 keeps track of everything that have been included in the current selection of recorded videos and then have been viewed or moved to archive or deleted. Videos that were replaced by ones of greater interest are not included in do-not-select list. A record 32 of the list 33 contains a program ID number, program title and date of inclusion in the list. If the date is specified, the record 32 will be stored for three years; if not, it will be stored permanently. If the program ID of record 31 matches the program ID of any record 32, the program is not considered for automatic selection. However the user can select any video no matter whether it is included in do-not-select list or not.

The next step provides selection of high quality video content that is compliant with user preferences. A user data record 34 contains data representing user preferences related to video content. User objections related to video content are treated hereafter as negative “preferences”. Because the selection system is looking for content with high impartial ratings the negative preferences are at least as important as positive ones.

The record of each available video program is processed against the user record according to decision tables 35, which will be illustrated hereafter. In a decision table, the program attributes pertinent to user preferences are compared with user data representing the preferences. For a particular combination of user data and program data, a decision table specifies a value of change to be applied to the program impartial rating in order to produce a personal rating. The change may be positive, negative or equal to zero and the personal rating, which is calculated as algebraic sum, may respectively be an increased, decreased or unchanged impartial rating. All video programs, which can be judged impartially on their quality or significance, are rated in the program information database from 1 to 5 while 0 is reserved for “not applicable”. Personal ratings are also rated from 1 to 5 as follows:

if I + C > 5 then P = 5
else if I + C < 1 then P = 1
else P = I + C

wherein I is the impartial rating, C is the positive or negative value of change and P is the personal rating. An expansion beyond 1 to 5 range would reduce the intuitiveness of the ratings.

For certain combinations of user data and program attributes pertinent to the user data, the decision table specifies selection or rejection of video program no matter what is the program impartial rating. Output records 36 of video programs, which have been neither selected nor rejected, are sorted by personal rating and programs with the highest personal ratings, i.e. those that are impartially the best and compliant with user individual preferences, are added to a selection list to be presented to the user. Thus videos with higher personal ratings are considered of greater interest to the user than videos with lower personal ratings.

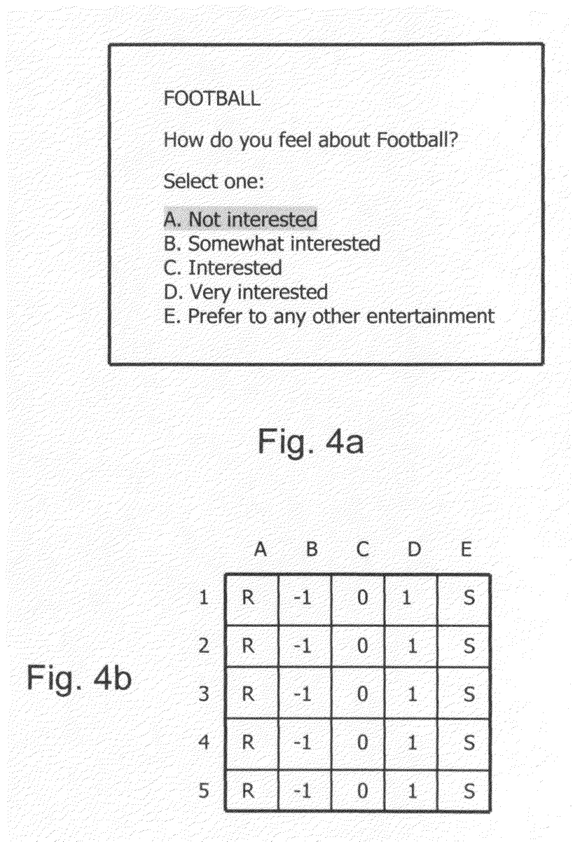

User preferences are acquired in an interactive profile development session, which the user enters from the main menu shown in FIG. 1. In the session, the system presents a question related to a particular aspect of video content and five answers to select from. For sports, it is illustrated by FIG. 4a. Each answer from A to E indicates a level of user interest in a particular sport, for example, football. FIG. 4b shows the decision table. In the table, R stands for rejection and S for selection. The answer A is the default and if the user does not select other answer, a football event will never be selected automatically no matter how significant the event is. If the user selects the answer E, a football event will always be selected no matter how insignificant it is. The significance of sport event is indicated by its impartial rating. Events that involve leaders or local teams have higher impartial rating than other events and Super Bowl, as the most significant football event, has the highest impartial rating. The user answer B reduces the personal rating by one point, and therefore reduces chances of football event to be selected. The answer C keeps the personal rating equal to impartial rating. The answer D increases the personal rating by one point and thus increases chances of football event to be selected.

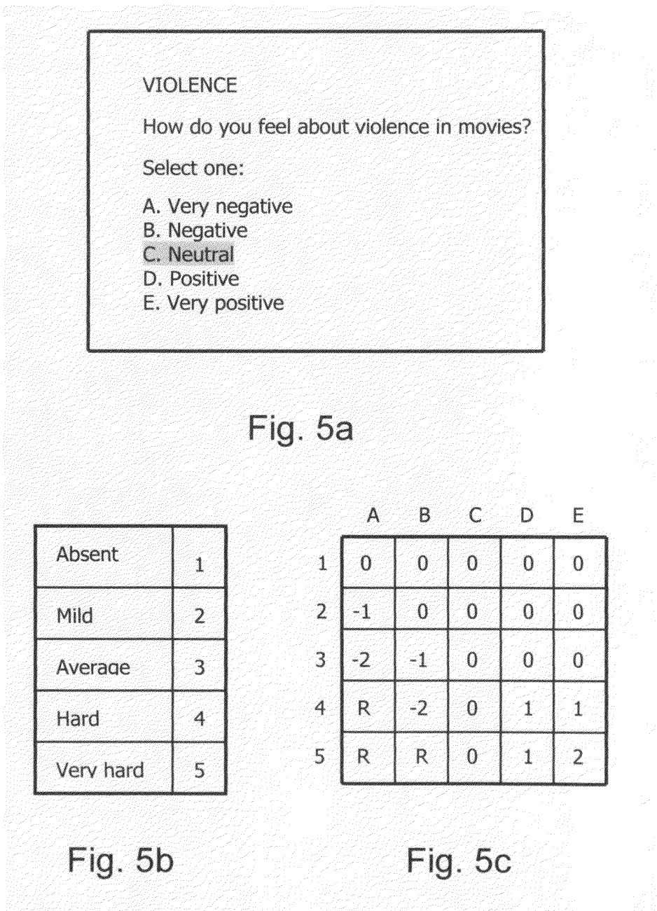

Acquisition and processing of user data related to controversial features of video content are illustrated by FIG. 5, for violence as the example. A program attribute that indicates the level of violence in the program may have five different values (FIG. 5b): absent, mild, average, hard and very hard. The values are determined by professionals whose job is populating the program information database. They may rely on their own judgement, expert advice and all available information. The decision table (FIG. 5c) exercises “fuzzy logic”: even if the user is negative about violence, a violent movie still may be selected provided that the movie is very good and the violence is not very hard. User preferences related to sex, “adult” language, horror, indecency and black humor are captured and processed similarly.

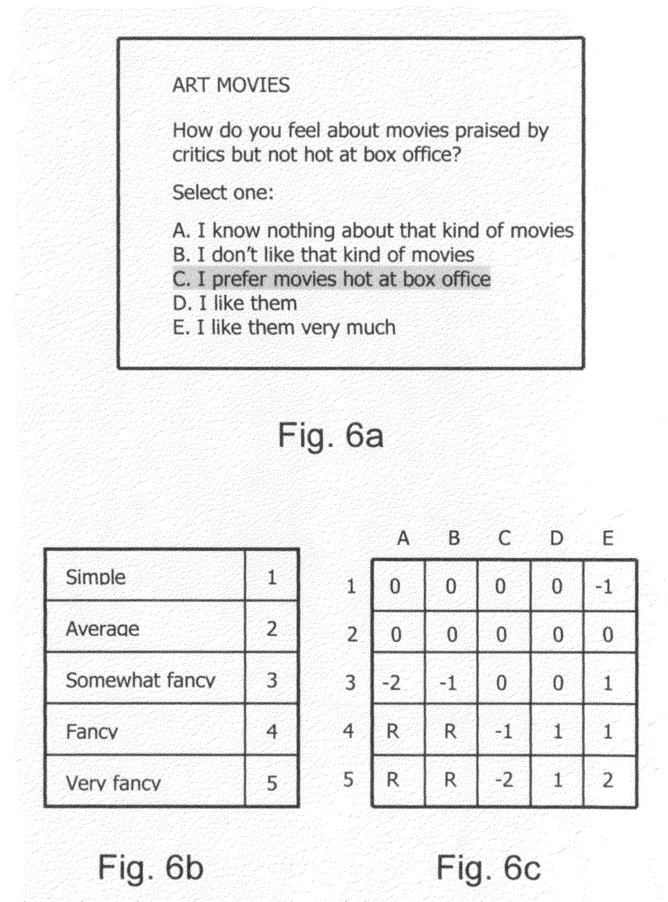

The controversial features of video content are not the only area of concern for automatic program selection that relies on impartial ratings. For many viewers, some movies are too fancy to enjoy. As creations of great masters of cinema, the “art” movies often have high impartial ratings. The FIG. 6 shows how the system deals with this problem. A movie attribute that characterizes the level of sophistication may have five different values (FIG. 6b): simple, average, somewhat fancy, fancy and very fancy. The values are determined by professionals who may rely on their own judgement, expert advice or other available sources. The system presents a question about this kind of movies in a form that any user understands enough to select one of 5 answers (FIG. 6a). Depending on the answer selected by the user, the decision table (FIG. 6c) either rejects the movie or changes its chances to be selected. The table is composed so that the art movies would be selected only for right viewers.

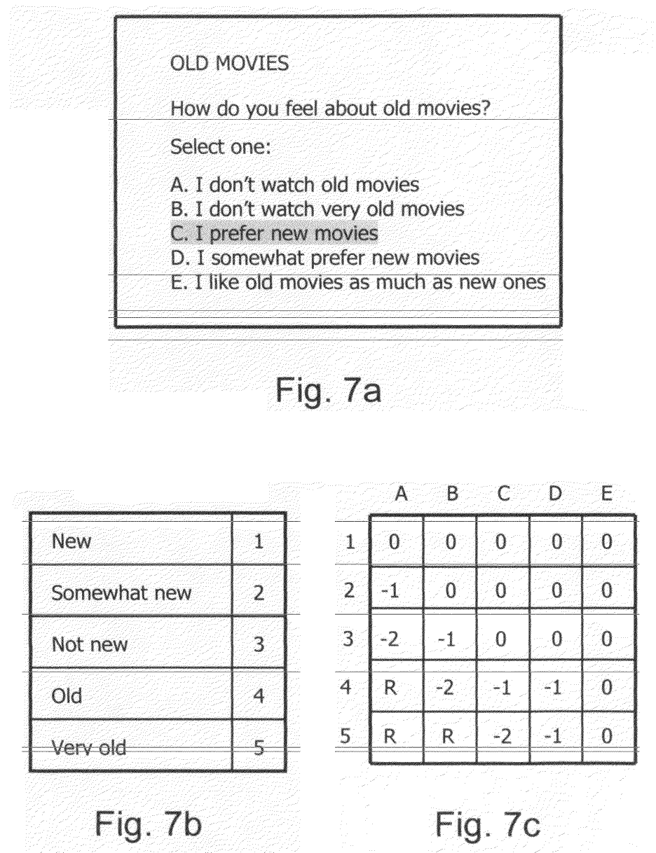

Another aspect to be addressed is the movie age. Only good old movies are run on television but generally movies are fads. The FIG. 7 shows how the system deals with the age problem. Movie age is determined from the issue date included in the program record. Depending on the age, all movies are divided in five categories: new (0 to 3 years), somewhat new (4 to 10 years), not new (11 to 20 years), old (21 to 60 years) and very old (more than 60 years). Depending on the answer selected by the user (FIG. 7a), the decision table (FIG. 7c) either rejects the movie or changes its chances to be selected.

When more than one decision tables are involved in the selection process of a video program, an aggregate value of change to be applied to the impartial rating is determined by the most positive and the most negative results produced by the decision tables. Let C₁, C₂, . . . , C_{N} be results that are produced by N decision tables and

Cₘₐₓ=max(C₁, C₂, . . . , C_{N})

Cₘᵢₙ=min(C₁, C₂, . . . , C_{N})

keeping in mind that 1<2 and −1>−2. Then the aggregate value of change C to be applied to the impartial rating is determined as follows:

if Cₘₐₓ > 0 and Cₘᵢₙ < 0 then C = Cₘₐₓ + Cₘᵢₙ
else if Cₘₐₓ > 0 then C = Cₘₐₓ
else if Cₘᵢₙ < 0 then C = Cₘᵢₙ
else C = 0

The automatic video content selection system provides reasonable default values for user data, which are highlighted in FIG. 4a-FIG. 7a. If the user does not change the values in a profile development session the system uses the defaults for selecting video content.

Television series, which can be judged impartially on their quality or significance, may be selected in two different ways depending on how the user has set his profile. Series that are already known to the user can be selected similar to the sport events, i.e. based on a level of user interest in a particular sequel. Series that are unknown to the user, can be selected similar to movies. In both cases different episodes may have different impartial rating thereby providing flexibility of the selection.

News and numerous talk shows cannot be judged impartially on their quality or significance and therefore have impartial rating equal 0, which stands for “not applicable”. However they are transmitted on a regular basis, which makes selection easier. If the user selects such a program, its latest version will appear in the current selection of recorded programs until the user deletes it. While old versions of news and news-based shows do not present much interest, the user can save any version in archive before it is replaced by the latest version in a new recording cycle.

Although the invention is described herein with reference to the preferred embodiment, it is to be understood that modifications can be made by those skilled in the art without departing from the spirit or scope of the invention. Accordingly, the invention should only be limited by the claims included below.

I claim:

1. A system for automatic selection of video programs from a plurality of programs available in a video distribution network, comprising:
means for providing user data representing user preferences;
means for providing program data of each available video program, said data containing program attributes pertinent to user preferences and a program impartial rating, which is an impartial assessment of the program in regard to its quality or significance and with no regard to preferences of individual users; and
evaluation means coupled with the means for providing user data and the means for providing program data for processing program data against user data, said processing being defined by at least one decision table;
wherein for a particular combination of user data and said program attributes pertinent to user preferences, the decision table specifies a value of change to be applied to said program impartial rating in order to produce a personal rating as an increased, decreased or unchanged impartial rating;
said evaluation means further being operative for selecting limited number of video programs with the highest personal ratings;
thereby providing selection of high quality video content that is compliant with user preferences.

4. The system of claim 1, wherein for a certain combination of user data and program attributes pertinent to user preferences, the decision table specifies selection of video program no matter what is the program impartial rating.

3. The system of claim 1, wherein for a certain combination of user data and program attributes pertinent to user preferences, the decision table specifies rejection of video program no matter what is the program impartial rating.

4. The system of claim 1, wherein said plurality of available video programs is a plurality of programs scheduled for transmission in the current time zone and therefore any selected program is available for immediate viewing.

5. The system of claim 1, wherein said plurality of available video programs is a plurality of programs scheduled for transmission during a certain programming cycle and therefore any selected program can be automatically recorded during that cycle.

6. The system of claim 1, wherein said plurality of available video programs is a plurality of programs available on demand.

7. The system of claim 5 further comprising means for recording selected video programs.

8. The system of claim 7 further operative for replacing a video program recorded in a previous recording cycle by a program with a higher personal rating if such a program is scheduled for transmission during a new recording cycle, thereby providing over time an accumulation of video programs of the most personal interest to the user so that a user would never miss the best programs no matter at what time the programs are transmitted and how much time the user spends on watching television.
